(19) United States
(12) Patent Application Publication
(10) Pub. No.: US 2014/0265246 A1
(43) Pub. Date: Sep. 18, 2014

(54) TRAILER TONGUE LOCK & GUIDE

(71) Applicant: Douglas Mackey, Loxahatchee, FL (US)

(72) Inventor: Douglas Mackey, Loxahatchee, FL (US)

(21) Appl. No.: 13/794,943

(22) Filed: Mar. 12, 2013

(51) Int. Cl. B60D 1/36

(52) U.S. Cl. CPC B60D 1/363
USPC 280/477

(57) ABSTRACT

A device having a first member disposed at an angle with a second member such that the first member is integral with the second member along a first edge there between having a mounting plate attached to top edges of the first and second member respectively and a mounting spheroid attached to a portion of the mounting plate lying between the first and second members. The device further has a first extension integral with the first member and a second extension integral with the second member. Additionally, there is a first extension disposed at an angle and a second extension disposed at an angle. Finally, a first vertical flange is perpendicularly disposed to a top surface of the mounting plate and a second vertical flange is perpendicularly disposed to a top surface of the mounting plate and at an edge of the mounting plate.

### FIELD OF THE INVENTION

The present invention relates to a mechanism and system for guiding vehicles that are approaching in reverse. More particularly, the present invention relates to a trailer tongue lock and guide for helping a user back up in reverse so as to permit proper positioning of a vehicle approaching a trailer attachment point.

### BACKGROUND OF THE INVENTION

Modern life permits persons with the luxury of time to enjoy the outdoors using backpacks, boating/boat trailers, tents and trailers. The last of these is commonly attached to a vehicle using a trailer hitch point that is a concavity formed on the trailer hitch for insertion of a metal ball affixed to the back of the aforementioned vehicle. First, a user places his vehicle in reverse turns back or uses the rear view mirror to scan for the trailer. Once located, the user slowly backs up the vehicle as carefully as possible. However, it is usually not possible to perfectly align the vehicle as it is difficult to properly align the concavity and its attachment sphere.

Accordingly, there remains a need to make it easier for aligning a vehicle to the trailer concavity by providing a visual cue to the proper alignment of the vehicle. Also, there is a need to guide vehicular motion and align a trailer to the vehicle trailer hitch area. Additionally, there is a need for a trailer lock that is easy to mount, resilient to the elements and affordable.

### SUMMARY OF THE INVENTION

A device used to guide vehicular motion comprising: a first member disposed at an angle with a second member such that the first member is integral with the second member along a first edge there between a mounting plate attached to top edges of the first and second member respectively and a mounting spheroid attached to a portion of the mounting plate lying between the first and second members.

In another aspect, a first extension integral with the first member.

In another aspect, a second extension integral with the second member.

In another aspect, the first extension is disposed at an angle from a centerline between the first and second members.

In another aspect, the second extension is disposed at an angle from a centerline between the first and second members.

In another aspect, a first vertical flange perpendicularly disposed to a top surface of the mounting plate and at an edge of the mounting plate.

In another aspect, a second vertical flange perpendicularly disposed to a top surface of the mounting plate and at an edge of the mounting plate.

An attachment system comprising: a plate attached atop an angled pair of integral legs such that the plate has a mounting spheroid set on top of it between the integral legs.

In another aspect, a first vertical flange perpendicularly disposed to a top surface of the mounting plate and at an edge of the mounting plate.

In another aspect, a second vertical flange perpendicularly disposed to a top surface of the mounting plate and at an edge of the mounting plate.

In another aspect, a first extension integral with a first one of the legs.

In another aspect, a second extension integral with a second one of the legs.

In another aspect, the first extension is disposed at an angle from a centerline between the first and second legs.

In another aspect, the second extension is disposed at an angle from a centerline between the first and second legs.

A tongue lock and guide a spherical attachment point connected to a top of a flat planar surface such that the spherical attachment point is located forward of an arrowhead shaped guide attached to the underside of the flat planar surface.

In another aspect, a first vertical flange perpendicularly disposed to a top surface of the flat planar surface and at an edge of the flat planar surface.

In another aspect, a second vertical flange perpendicularly disposed to a top surface of the flat planar surface and at an edge of the flat planar surface.

In another aspect, a first extension integral with a portion of the arrowhead shaped guide.

In another aspect, a second extension integral with another portion of the arrowhead shaped guide.

In another aspect, the first extension and second extension are disposed at an angle from a centerline in the arrowhead guide.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1a presents an illustration of the top plate of a tongue lock and guide for the holding of the sides of a trailer hitch. FIG. 1b presents an illustration of the two wings of the tongue lock and guide that are to be utilized to guide the vehicle in towards the attachment point. FIG. 1c presents an illustration of a completed tongue lock and guide as taught in this embodiment.

FIG. 2a presents an illustration of a vehicle positioned above the device in an embodiment; here the vehicle or trailer is provided with a trailer spherical attachment and a trailer hitch concavity utilizing the trailer tongue lock and guide. FIG. 2b illustrates the attachment of the trailer tongue lock and guide with the trailer spherical attachment and trailer hitch concavity.

FIG. 3a illustrates a vehicle backing up to a trailer having a trailer tongue lock and guide. FIG. 3b illustrates the attachment of a vehicle to a trailer using the trailer tongue lock and guide. FIG. 3c illustrates a vehicle removing the connection between it and a trailer. FIG. 3d illustrates a vehicle being attached to a connection between it and a trailer.

FIG. 4a illustrates a front isometric view of a trailer tongue lock and guide. FIG. 4b illustrates a back isometric view of trailer tongue lock and guide.

FIG. 5a illustrates a top view of trailer tongue lock and guide. FIG. 5b illustrates a bottom view of a trailer tongue lock and guide.

FIG. 6a illustrates a side view of trailer tongue lock and guide. FIG. 6b illustrates a front view of a trailer tongue lock and guide.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 1a-1c presents various views 100 including partial components of the device and a finished view of the tongue lock and guide of the embodiment taught herein. FIG. 1a presents an illustration of the top plate of a tongue lock and guide for the holding of the sides of a trailer hitch. A flat square metal (typically iron or steel coated with an anti-rust paint) plate 115 is arranged horizontally in the figure having two perpendicular flanges 105, 110. Each of these flanges 105, 110 is arranged vertically on opposite sides of each other; additionally, they are rectangular and extend for only a portion of the side length of the square mounting plate 115. Starting from the left end at the front edge of the square plate 115 the flange 105 extends almost halfway down the length the front of the plate. Similarly, starting from the left end at the rear edge of the square plate 115 the flange 105 extends almost halfway down the length the rear edge of the plate. Finally a large metal (typically iron or steel coated with an anti-corrosion paint) spheroid 120 is attached to the mid right side of the plate 115; this spheroid 120 acts as an attachment point for the tongue lock and guide.

FIG. 1b presents an illustration of the two wings of the tongue lock and guide that are to be utilized to guide the vehicle in towards the attachment point. The tongue lock and guide has essentially two wings 101 (125, 130) and 102 (135, 140) disposed at an angle A there between the innermost parts of the wings. The innermost parts 130, 135 of the two wings 101, 102 are made from two oblong rectangular members made from a suitable metal (typically iron or steel coated with an anti-corrosion paint); these two components 130, 135 are integrated at an edge 145 of both and are disposed at an angle A there between such that the connection between the two oblong rectangular members 130, 135 is at the apex of a triangle-like shape. Further, both innermost members 130, 135 are each integrated with a final portion 125, 140 at an edge 103, 104 respectively that each extend the wings 101, 102 at an angle B from the original centerline C. These final portions are made from the same material as the innermost parts 130, 135 and are of the same height but of different length than the innermost parts 130, 135.

FIG. 1c presents an illustration of a completed tongue lock and guide as taught in this embodiment. The bottom of metal plate 115 is welded to the top longitudinal edges of members 130, 135 such that the right side of the metal plate having a spherical ball extends out between the two innermost parts 130, 135. This thereby permits easy access to the spheroid with a flat top for attachment to a concavity in an attachment device affixed to a trailer or similar device. Also, the left side of the metal plate 115 extends outwards to the left over the edge 145 that is shaped like an apex of a triangle connecting the two innermost parts 130, 135.

FIG. 2 presents an illustration of a vehicle 200 provided with a trailer spherical attachment 210 and a trailer hitch concavity 230 utilizing the trailer tongue lock and guide 220. The trailer tongue lock and guide 220 is inserted within the trailer hitch concavity 230 and locked in place. Then a user can more easily guide his or her vehicle using the wings 101, 102 previously described.

One exemplary implementation of the invention has the following dimensions (all in inches) for a 1⅞″ or 2″ spheroid, the width of the metal plate 115 (between the legs of triangular shape) is 4¾″ whilst the length would be 5″; the tabs or flanges are 1″ height and 2″ long whilst the distance between the outermost ends of (125, 140) the triangle are spread 12⅝″ and the triangle legs length are 8½″ from the tip of the outermost edges of 125, 140 to the edge 145 between the innermost portions. Finally, the height of the legs are 2.″

A second exemplary implementation of the invention has the following dimensions (all in inches) for a 2 5/16″ spheroid, the width of the metal plate 115 (between the legs of triangular shape) is 5⅞″ whilst the length would be 5 15/16″; the tabs or flanges are 1″ height and 2¼″ long whilst the distance between the outermost ends of (125, 140) the triangle are spread 15″ and the triangle legs length are 10″ from the tip of the outermost edges of 125, 140 to the edge 145 between the innermost portions. Finally, the height of the legs are 2⅞.″

It should be apparent that the materials are of such a character that they must resist slight impacts from vehicles and that the choice of materials composing the tongue lock and guide is chosen accordingly. Thus, inventor has chosen to use iron or steel as a principle material but any similarly suitable material would also suffice. Additionally, it should be readily apparent because of the nature of the herein disclosed embodiments that the various components are welded together as needed when it is disclosed as being ‘integral’ or ‘connected’ thereto or similar terminology; further, these components can also be made from a single component that is die cast or other manufacturing process. The above described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention will include all possible embodiments and modifications thereof that fall within the scope of the appended claims.

What is claimed is:

1. A device used to guide vehicular motion comprising:
a first member disposed at an angle with
a second member such that the first member is integral with the second member along a first edge there between
a mounting plate attached to top edges of the first and second member respectively and
a mounting spheroid attached to a portion of the mounting plate lying between the first and second members.

2. A device of claim 1, further comprising:
a first extension integral with the first member.

3. The device of claim 2, further comprising:
a second extension integral with the second member.

4. The device of claim 2, wherein the first extension is disposed at an angle from a centerline between the first and second members.

5. The device of claim 3, wherein the second extension is disposed at an angle from a centerline between the first and second members.

6. The device of claim 1, further comprising:
a first vertical flange perpendicularly disposed to a top surface of the mounting plate and at an edge of the mounting plate.

7. The device of claim 6, further comprising:
a second vertical flange perpendicularly disposed to a top surface of the mounting plate and at an edge of the mounting plate.

8. An attachment system comprising:
a plate attached atop
an angled pair of integral legs such that the plate has
a mounting spheroid set on top of it between the integral legs.

9. The attachment system of claim 8, further comprising:
a first vertical flange perpendicularly disposed to a top surface of the mounting plate and at an edge of the mounting plate.

10. The attachment system of claim 9, further comprising:
a second vertical flange perpendicularly disposed to a top surface of the mounting plate and at an edge of the mounting plate.

11. The attachment system of claim 8, further comprising:
a first extension integral with a first one of the legs.

12. The attachment system of claim 11, further comprising:
a second extension integral with a second one of the legs.

13. The attachment system of claim 11, further comprising wherein the first extension is disposed at an angle from a centerline between the first and second legs.

14. The attachment system of claim 12, further comprising wherein the second extension is disposed at an angle from a centerline between the first and second legs.

15. A tongue lock and guide comprising:
a spherical attachment point connected to a top of
a flat planar surface such that the spherical attachment point is located forward of
an arrowhead shaped guide attached to the underside of the flat planar surface.

16. The tongue lock and guide of claim 15, further comprising:
a first vertical flange perpendicularly disposed to a top surface of the flat planar surface and at an edge of the flat planar surface.

17. The tongue lock and guide of claim 16, further comprising:
a second vertical flange perpendicularly disposed to a top surface of the flat planar surface and at an edge of the flat planar surface.

18. The tongue lock and guide of claim 15, further comprising:
a first extension integral with a portion of the arrowhead shaped guide.

19. The tongue lock and guide of claim 16, further comprising:
a second extension integral with another portion of the arrowhead shaped guide.

20. The tongue lock and guide of claim 19, further comprising wherein the first extension and second extension are disposed at an angle from a centerline in the arrowhead guide.
